(19) United States
(12) Patent Application Publication
(10) Pub. No.: US 2026/0189811 A1
(43) Pub. Date: Jul. 2, 2026

(54) INCREASED DRONE DETECTION RANGE WITH ASYMMETRIC DEPTH OF FOCUS

(71) Applicants: NATIONAL RESEARCH COUNCIL OF CANADA, Ottawa (CA); HIS MAJESTY THE KING IN RIGHT OF CANADA, AS REPRESENTED BY THE MINISTER OF NATIONAL DEFENCE, Ottawa (CA)

(72) Inventors: Antony Orth, Ottawa (CA); Terrence Stewart, St. Clements (CA); Michel Picard, Orleans (CA); Marc-Antoine Drouin, Gatineau (CA); Daniel Webber, Ottawa (CA); Guillaume Gagne, Quebec (CA)

(21) Appl. No.: 19/130,216

(22) PCT Filed: Nov. 16, 2023
(86) PCT No.: PCT/IB2023/061605

§ 371 Date: May 15, 2025

Related U.S. Application Data
(60) Provisional application No. 63/460,263, filed on Apr. 18, 2023.

(30) Foreign Application Priority Data
Nov. 17, 2022 (CA) 3183634

(51) Int. Cl. H04N 25/47; H04N 23/55

(52) U.S. Cl. CPC H04N 25/47; H04N 23/55

(57) ABSTRACT

A method and apparatus for detecting drones via the insertion of asymmetric depth of focus in an optical path, inducing selective blurring along a single axis and thus allowing for filtering of events in a single axis.

### FIELD OF THE INVENTION

This invention relates to the detection of drones and more specifically to increasing drone detection range with asymmetric depth of focus.

### BACKGROUND

In recent years, the use of drones (also Unmanned Aerial Vehicles or UAVs) for recreational and commercial activities has grown rapidly due to their affordability and performance. This growing use raises concerns about the threats drones pose to the security of sensitive areas such as airports, prisons, industrial and military facilities. In response to these threats, drone detection methods are being actively developed. While such detection method development is driven by security, it is further applicable to drone management and operation generally.

While regulations restrict unmanned vehicles they mainly do so by regulating the qualifications for operators. In order to buttress the qualification based mode of regulation, it is desirable to apply UAV detection at, for instance, the aforementioned sensitive locations. In order to detect and track drones, there is a need to discriminate between them and other objects.

More specifically, it is desirable to increase the parameters of drone detection: efficiency, accuracy, range, etc.

### SUMMARY

According to one aspect of the invention there is described in more detail herein a detection apparatus comprising:
a custom aperture stop, and
an event camera having an event sensor,
wherein the arrangement of the custom aperture stop and event camera divides events according to orientation and suppresses events in at least one such orientation.

Variants of this aspect also described herein include: The detection apparatus wherein the aperture stop precedes a event sensor of the event sensor in an optical path; The detection apparatus wherein the orientation is a plane perpendicular to an optical path of the apparatus; The detection apparatus wherein events not in said one orientation are not suppressed; The detection apparatus wherein events not in said one orientation are enhanced; The detection apparatus wherein said custom aperture stop is at least one of a cylindrical lens, a rectangular slit, and a diffraction grating; The detection apparatus wherein said events are further categorized based on one of period and frequency;

According to another aspect, described herein is a method of detection of events comprising:
spatial filtering, and
differential detection of intensity,
wherein the events are divided according to orientation and suppressed according to at least one such orientation.

Variants of this other aspect include: The method wherein the spatial filtering precedes the differential detection in an optical path; The method wherein the orientation is a plane perpendicular to an optical path of the spatial filtering and differential detection; The method wherein events not in said one orientation are not suppressed; The method wherein events not in said one orientation are enhanced; The method wherein said spatial filtering is performed by a rectangular slit; The method wherein said events are further categorized based on one of period and frequency; The method wherein said period is a temporal period.

### BRIEF DESCRIPTION OF THE DRAWINGS

The drawings have not necessarily been drawn to scale. Similarly, some components and/or operations can be separated into different blocks or combined into a single block for the purposes of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

FIG. 1 is a comparative diagram of various drone and detector configurations alongside corresponding images.

FIG. 2 is a series of photographs showing the insertion of an asymmetric stop in a commercial lens.

FIG. 3 is a comparative set of real result images according to some of the image-configuration pairs of FIG. 1.

FIG. 4 demonstrates the signal to noise improvement achieved according to an aspect of the invention.

### DETAILED DESCRIPTION

Systems and methods for aerial unmanned vehicle (for example, drone) detection are described herein. While the disclosure uses the term “drone,” one of ordinary skill in the art would understand that the discussion would apply to other similar unmanned vehicles. Various implementations discussed below address different aspects of the infrastructure needed for detecting drones

In the following description, for the purposes of explanation, numerous specific details are set forth in order to provide a thorough understanding of implementations of the present technology. It will be apparent, however, to one skilled in the art that implementations of the present technology can be practiced without some of these specific details.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some implementations,” “according to some implementations,” “in the implementations shown,” “in other implementations,” and the like generally mean the particular feature, structure, or characteristic following the phrase is included in at least one implementation of the present technology, and can be included in more than one implementation. In addition, such phrases do not necessarily refer to the same implementations or different implementations.

Neuromorphic cameras are a type of camera that can be used for detecting unscrewed aerial vehicles. Unlike traditional cameras that record the intensity of light and produce an image of the target, a neuromorphic camera records variation in the light intensity in time. This can be thought of as a differential or first order derivative of the intensity.

These changes in light-intensity, or events, are why neuromorphic cameras are commonly called event cameras. Specifically for the purposes of this invention, it is particularly beneficial to employ pixilated event cameras, which are binary i.e. each pixel event represents a change (positive or negative) in intensity.

Event cameras are advantageous over traditional cameras for high-speed imaging since, for the same image size, they transmit less data allowing for faster image capture. This is because only the variation in light intensity is recorded in an event camera, allowing for the data stream to contain only the data of interest (i.e. a moving drone blade) and not contain nonessential information (i.e. stationary background).

Using known methods, the maximum detection range of an event camera using leveraged artificial intelligence (AI) to detect the periodic motion signature of a rotating drone blade is determined by the minimum number of pixels on the event camera sensor the drone's blade is recorded on. If the drone is too far away, the drone blade covers a smaller number of pixels, and goes undetected.

The maximum range of current neuromorphic drone detection equipment is limited by the signal-to-noise ratio of the acquired signal and based on a minimum number of pixels in the neuromorphic image required to achieve that minimum signal-to-noise ratio.

According to one aspect of the invention, optical filtering is applied to incident light prior to the neuromorphic sensor to increase the signal-to-noise ratio and thereby the detection range and capability of the drone detection system.

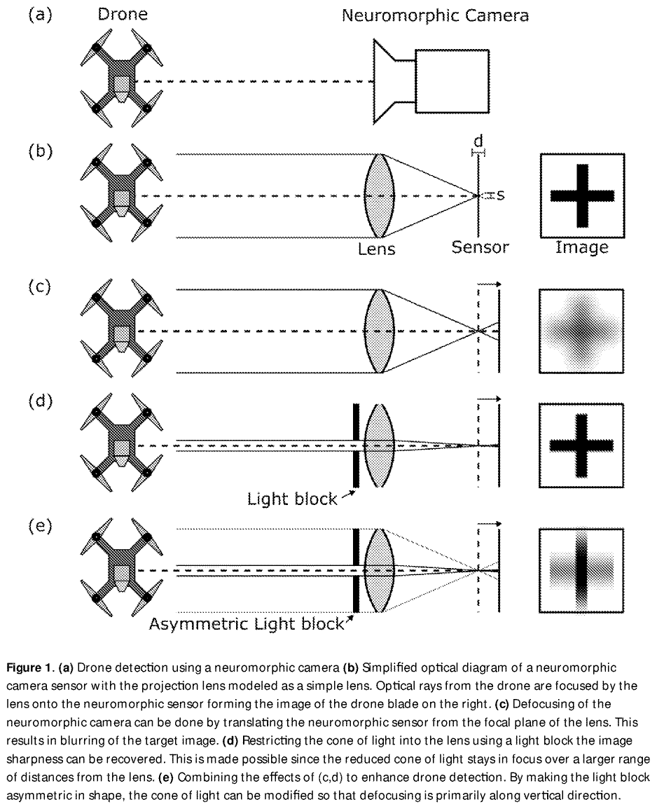

Optical filtering of the incident light is achieved by modifying the camera lens of the neuromorphic camera to have an asymmetric depth of focus. In FIG. 1(a) is a simple diagram of a neuromorphic camera imaging a drone, and in FIG. 1(b) is an optical ray diagram for the same system where the camera has been modeled as a single lens imaging onto a neuromorphic sensor. The depth of focus is distance between an imaging lens and image sensor such that the image being recorded appears in focus to the human eye. In FIG. 1(b) the sensor is placed at the point of best focus but can be moved anywhere within the depth of focus (labeled d) while maintaining an acceptable amount of blur (labeled s). If the image sensor is placed beyond the depth of focus the object being imaged will appear blurred as shown in FIG. 1(c).

Depth of focus in a camera is determined by the cone of light the camera lens records. The larger the cone of light, the smaller the depth of focus. In practice, the cone of light is adjusted by adjusting the inner diameter of a circular light blocking element called the aperture stop. An example of this is shown in FIG. 1(d) where a smaller aperture stop (e.g. a pinhole) has been used, increasing the depth of focus, allowing for the object to be imaged clearly.

Asymmetric depth of focus can be achieved by inserting a custom asymmetric light blocking element at the location of the lenses' aperture stop, as shown in FIG. 1(e). Here, the aperture stop is made of rectangular slit so that along one direction (e.g. in the plane of the paper) the aperture stop is large, passing a large cone of light resulting in a small depth of focus. Perpendicular to this direction (e.g. normal to the plane of the paper) the slit is narrow, passing a small cone of light resulting in a large depth of focus. As a result, the image of the object will appear blurred along the direction parallel with the larger slit.

The combination of the blurring resulting from an out of focus condition, with the differential function results in a general suppression of events. In the case of the rectangular slit and event camera combination described above, the general suppression excepts differential events that occur parallel to the slit e.g. a propeller momentarily lining up with the slit. i.e. the rectangular slit divides events by orientation, suppressing one divided group.

In neuromorphic drone detection this is advantageous as it enables spatial filtering of the captured image without computer computation, reducing unwanted background noise (and increasing detection capabilities) and favoring speed of detection, as no additional computation is required. Furthermore, as blurring does exist not just to suppress non-aligning instantaneous objects, but also that blurring occurs along the pixels of the slit direction, the detected objects are enlarged by the effect, further improving range.

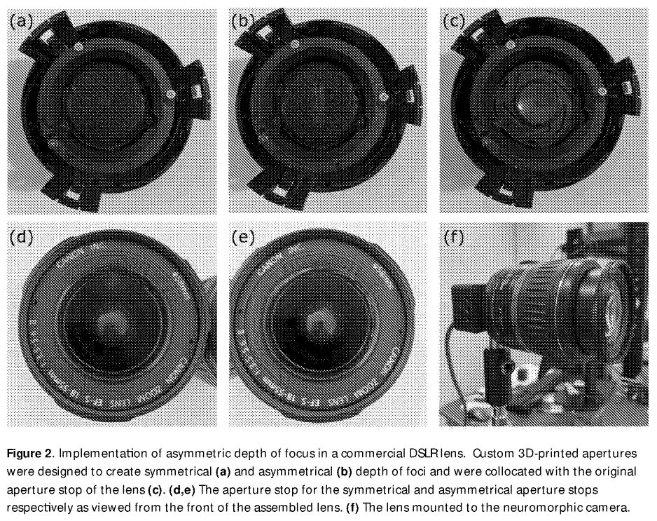

A physical implementation of the asymmetric depth of focus is shown in FIG. 2. A skilled person would understand the construction of this apparatus. However, according to several aspects of the invention: A custom aperture stop may serve as the rectangular slit. It may be made using 3D printing. It may be installed into a consumer-grade digital single lens reflex (DSLR) camera lens. The custom part may be collocated with the original lens aperture stop so that only the depth of focus properties were modified.

In FIG. 2(a,b) are the symmetric and asymmetric aperture stops as may be mounted in the DSLR lens, and FIG. 2(d,e) are the same stops viewed through the front of the assembled lens. In FIG. 2(f) is the DSLR lens as may be mounted to the neuromorphic camera.

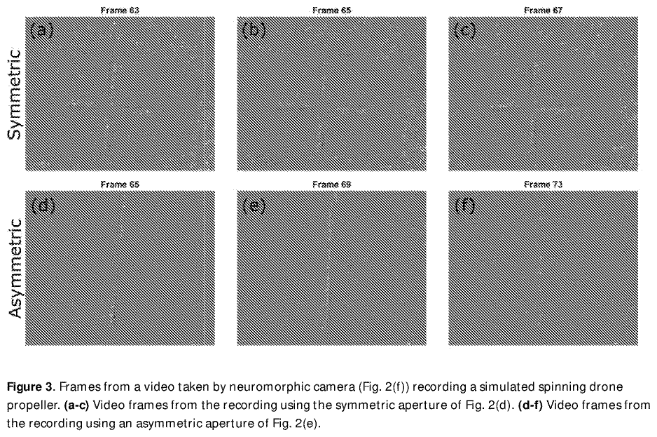

Spatial filtering via the asymmetric depth of focus will reduce unwanted background noise. In FIG. 3 are frames captured from videos recorded using the neuromorphic camera according to FIG. 2. As a proof of concept, a spinning propeller blade was simulated by displaying a video of a spinning black “+” on a white background on a laptop screen. For the symmetric case, FIG. 3(a-c), the blade is visible for all frames since the depth of focus is uniform in all directions and so the blade stays in focus for all blade orientations. Here, there is a large amount of background noise surrounding the simulated drone blade. For the asymmetric case in FIG. 2(d-f) the drone blade is only visible when parallel to the long-axis of the aperture stop. In contrast to the symmetric case, the size of the detected blade is elongated indicating an increase in detected signal. Furthermore, the overall background signal is reduced as evident by the decrease in white noise surrounding the drone blade.

The shape of the aperture in the lens with asymmetric depth of focus increases the light throughput in the camera, thereby increasing the signal-to-noise ratio of the camera and its maximum detection range. Detection of a spinning drone blade can be obtained by counting the number of events recorded by the neuromorphic camera within a specific temporal frequency window.

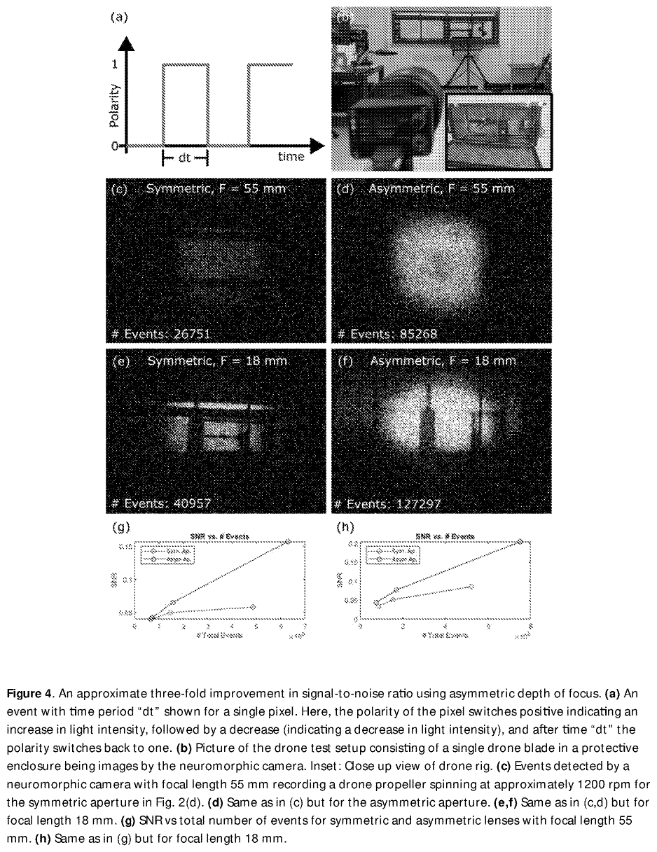

Shown in FIG. 4(a) is a diagram of the signal measured for a single pixel. When the pixel detects an increase in light intensity, it switches to “1”. When the same pixel detects a decrease in light intensity it switches back to “0”. After a time period “dt” the pixel detects a change in light intensity. If the value of this period is within a predicted range of the period of a spinning drone blade, then the measured event can be considered to represent a drone blade i.e. these conditions represent a detection.

The performance of the asymmetric depth of focus lens was tested using the apparatus shown in FIG. 4(b). A drone propeller blade located in a protective enclosure was set to rotate at approximately 1200 RPM (rotations per minute). 1200 RPM corresponds to dt=0.05 seconds. For this comparison, camera properties were set to be constant (sensitivity=3, sampling time 1 second) and only the lenses were changed. In FIG. 4 (c,d) are neuromorphic images taken with the symmetrical and asymmetrical depth of focus lenses respectively for events between 600 RPM and 2400 RPM with the lens in zoom mode (focal length=55 mm). The number of events detected within the window were 26751 and 86268, and 459057 and 542932 outside the window for the symmetrical and asymmetrical depth of focus lenses respectively. Taking the signal-to-ratio as # events within window/# events outside window, this corresponds to SNR of 0.059 and 0.156 for symmetric and asymmetric lenses respectively. This indicates an almost three-fold increase in detection performance using an asymmetric depth of focus lenses in drone detection.

The asymmetrical depth of focus lens recorded ˜30% more total events than the symmetrical lens (485808 vs. 628200) despite having 500% more light throughput due to the larger aperture. This indicates that the increased SNR of the asymmetric configuration isn't due to increased light throughput, but instead due to the asymmetric depth of focus.

The improvement in SNR is demonstrated in both zoom and wide field of view configurations. In FIG. 4 (c,d) was shown measured data for the zoom configuration. In FIG. 4 (e,f) are shown similar data for the wide viewing angle configuration (obtained by setting the focal length to 18 mm). An increase in SNR was also observed (˜2.5).

Assymetric DOF yields a higher SNR across a broad range of event camera sensitivities. In FIG. 4 (g,h) are shown the SNR vs. total event counts for both zoom and wide angle lens configurations. To make comparison easier, the SNR is plotted against total number of events (instead of sensitivity) so that the small light difference between configurations is included, and that a direct comparison can be made. We see that SNR for the asymmetric configuration is greater for all points in both zoom and wide angle, and that the SNR increases for increasing number of total counts.

The orientation of the asymmetric light blocking element determines the direction of spatial filtering. By orienting the filter along the path of motion of the neuromorphic camera one can remove light variation in the path of motion, decreasing unwanted signal which would manifest as background.

According to another aspect of the invention, either in conjunction or as an alternative to a rectangular slot, other optical dispersive elements such as a diffraction grating or cylindrical lens may be employed to create asymmetric depth of focus. In the case of conjunction, these elements can be sequentially placed along the optical path.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A detection apparatus comprising:
a custom aperture stop, and
an event camera having an event sensor,
wherein the arrangement of the custom aperture stop and event camera divides events according to orientation and suppresses events in at least one such orientation.

2. The detection apparatus of claim 1 wherein the aperture stop precedes a event sensor of the event sensor in an optical path.

3. The detection apparatus of claim 1 wherein the orientation is a plane perpendicular to an optical path of the apparatus.

4. The detection apparatus of claim 1 wherein events not in said one orientation are not suppressed.

5. The detection apparatus of claim 1 wherein events not in said one orientation are enhanced.

6. The detection apparatus of claim 1 wherein said custom aperture stop is at least one of a cylindrical lens, a rectangular slit, and a diffraction grating.

7. The detection apparatus of claim 1 wherein said events are further categorized based on one of period and frequency.

8. A method of detection of events comprising:
spatial filtering, and
differential detection of intensity,
wherein the events are divided according to orientation and suppressed according to at least one such orientation.

9. The method of claim 8 wherein the spatial filtering precedes the differential detection in an optical path.

10. The method of claim 8 wherein the orientation is a plane perpendicular to an optical path of the spatial filtering and differential detection.

11. The method of claim 8 wherein events not in said one orientation are not suppressed.

12. The method of claim 1 wherein events not in said one orientation are enhanced.

13. The method of claim 1 wherein said spatial filtering is performed by a rectangular slit.

14. The method of claim 1 wherein said events are further categorized based on one of period and frequency.

15. The method of claim 14 wherein said period is a temporal period.
